(19) United States
(12) Patent Application Publication
(10) Pub. No.: US 2009/0015776 A1
(43) Pub. Date: Jan. 15, 2009

(54) LIQUID CRYSTAL DISPLAY

(76) Inventor: Jae-Jin Lyu, Yongin-si (KR)

Correspondence Address: Frank Chau, Esq.;F. CHAU & ASSOCIATES, LLC, 130 Woodbury Road, Woodbury, NY, 11797, US

(21) Appl. No.: 12/118,249

(22) Filed: May 9, 2008

(30) Foreign Application Priority Data
Jul. 10, 2007 (KR) 10-2007-0069088

(51) Int. Cl. G02F 1/1343

(52) U.S. Cl. 349/143

(57) ABSTRACT

A liquid crystal display according to an embodiment of the present invention includes a first substrate and a second substrate facing each other, a common electrode formed on the first substrate, a pixel electrode formed on the second substrate, a liquid crystal layer disposed between the common electrode and the pixel electrode, and a polymer wall formed between the common electrode and the pixel electrode and dividing the liquid crystal layer into a plurality of linear regions.

### CROSS-REFERENCE TO RELATED APPLICATION

This application claims priority to and the benefit of Korean Patent Application No. 10-2007-0069088 filed in the Korean Intellectual Property Office on Jul. 10, 2007, the entire contents of which are incorporated herein by reference.

### BACKGROUND OF THE INVENTION

(a) Technical Field

The present invention relates to a liquid crystal display.

(b) Discussion of the Related Art

A liquid crystal display (LCD) is one of the most widely used flat panel displays. A liquid crystal display includes two panels provided with field-generating electrodes such as pixel electrodes and a common electrode, and a liquid crystal (LC) layer interposed therebetween. The LCD displays images by applying voltages to the field-generating electrodes to generate an electric field in the LC layer, which determines orientations of LC molecules in the LC layer to adjust polarization of incident light.

The LCD further includes a plurality of switching elements connected to the pixel electrodes and a plurality of signal lines such as gate lines and data lines for controlling the switching elements to apply voltages to the pixel electrodes. Among the LCDs, a vertical alignment (VA) mode LCD, which aligns LC molecules such that the long axes of the LC molecules are perpendicular to the panels in the absence of an electric field, exhibits a high contrast ratio and wide reference viewing angle.

The wide viewing angle of the VA mode LCD can be realized by cutouts in the field-generating electrodes and protrusions on the field-generating electrodes. Since the cutouts and the protrusions can determine the tilt directions of the LC molecules, the tilt directions can be distributed by appropriately arranging the cutouts and the protrusions such that the reference viewing angle is widened.

However, an additional mask is required to pattern the field generating electrodes for making the cutouts and the protrusions, and thereby manufacturing processes may be complicated and costs may be increased.

### SUMMARY OF THE INVENTION

The present invention has been made in an effort to provide a liquid crystal display that improves a viewing angle without requiring an additional patterning process.

A liquid crystal display according to an embodiment of the present invention includes a first substrate and a second substrate facing each other, a common electrode formed on the first substrate, a pixel electrode formed on the second substrate, a liquid crystal layer disposed between the common electrode and the pixel electrode, and a polymer wall formed between the common electrode and the pixel electrode and having a stem portion and a branch portion extended from the stem portion, wherein the liquid crystal layer is divided into a plurality of sub-regions by the stem portion of the polymer wall, and each sub-region is divided into a plurality of linear regions by the branch portion of the polymer wall.

The branch portion may obliquely extend from the stem portion or may extend substantially perpendicular to the stem portion.

The branch portions formed in two adjacent sub-regions may extend substantially perpendicular to each other.

The longitudinal edges of the pixel electrode may have an obtuse angle to transverse edges of the pixel electrode.

The width of the linear regions may become narrower from edges of the pixel electrode to the center of the pixel electrode.

The maximum width and the minimum width of the linear region may have a ratio of about 5:3.

The liquid crystal display may further include an alignment layer formed on at least one of the common electrode and the pixel electrode, and a side branch formed on the surface of the alignment layer.

The side branch may be made of the same material as the polymer wall.

The liquid crystal layer may include chiral dopants.

The chiral dopants may be contained in the liquid crystal layer such that a ratio of the pitch of the liquid crystal layer to the cell gap of the liquid crystal display is about 5 to about 150.

The polymer wall may be made of a material that is hardened by light.

The stem portion may include a middle transverse portion extending in a transverse direction, an upper oblique branch portion that is upwardly and obliquely extended from the middle transverse portion, and a lower oblique branch portion that is downwardly and obliquely extended from the middle transverse portion.

The upper oblique branch portion and the lower oblique branch portion may extend perpendicular to each other.

### BRIEF DESCRIPTION OF THE DRAWINGS

Exemplary embodiments of the present invention can be understood in more detail with reference to the accompanying drawings, in which:

FIG. 1 is an equivalent circuit diagram of a pixel of a liquid crystal display according to an embodiment of the present invention;

FIG. 2 is a layout view of a liquid crystal display according to an embodiment of the present invention;

FIG. 3 is a sectional view of the liquid crystal display shown in FIG. 2 taken along the line III-III;

FIG. 4 is a sectional view of the liquid crystal display shown in FIG. 2 taken along the line IV-IV;

FIG. 5 to FIG. 8 are layout views representing polymer walls and pixel electrodes of a thin film transistor array panel according to embodiments of the present invention, respectively;

FIG. 9 is a sectional view of a liquid crystal display according to an embodiment of the present invention; and

FIG. 10 is a flowchart representing a sequence of a manufacturing method for a liquid crystal cell of a liquid crystal display according to an embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., may be exaggerated for clarity. Like reference numerals may designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

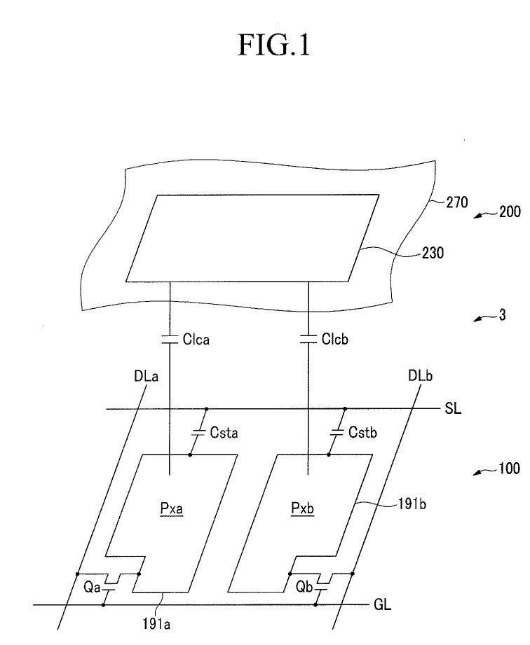

FIG. 1 is an equivalent circuit diagram of a pixel of a liquid crystal display according to an embodiment of the present invention.

Referring to FIG. 1, the liquid crystal display includes signal lines including a plurality of gate lines GL, a plurality of pairs of data lines DLa and DLb, and a plurality of storage electrode lines SL, and a plurality of pixels connected thereto.

Each pixel includes a pair of subpixels PXa and PXb. The subpixel PXa includes a switching element Qa connected to a gate line GL and a data line DLa, a liquid crystal capacitor Clca connected to the switching element Qa, and a storage capacitor Csta connected to the switching element Qa and a storage electrode line SL, and the subpixel PXb includes a switching element Qb connected to the gate line GL and a data line DLb, a liquid crystal capacitor Clcb connected to the switching element Qb, and a storage capacitor Cstb connected to the switching element Qb and the storage electrode line SL.

Each switching element Qa or Qb is disposed on the lower panel 100 and has three terminals, i.e., a control terminal connected to the gate line GL, an input terminal connected to the data line DLa or DLb, and an output terminal connected to the liquid crystal capacitor Clca or Clcb and the storage capacitor Csta or Cstb.

The liquid crystal capacitor Clca or Clcb include pixel electrodes 191a or 191b disposed on the lower panel 100 and a common electrode 270 disposed on the upper panel 200 as two terminals. The liquid crystal layer 3 disposed between the pixel electrodes 191a and 191b, and the common electrode 270, functions as a dielectric of the liquid crystal capacitor Clc.

The storage capacitors Csta and Cstb are auxiliary capacitors for the liquid crystal capacitors Clca and Clcb. The storage capacitor Csta or Cstb includes the pixel electrodes 191a or 191b, and a storage electrode line SL that is provided on the lower panel 100, overlaps the pixel electrodes 191a and 191b via an insulator, and is supplied with a predetermined voltage such as the common voltage Vcom.

The liquid crystal capacitors Clca and Clcb are charged with different voltages. The data voltage applied to the data line DLa is lower or higher than the data voltage applied to the data line DLb to charge the liquid crystal capacitors Clca and Clcb with different voltages. Accordingly, the lateral visibility of the liquid crystal display may be improved.

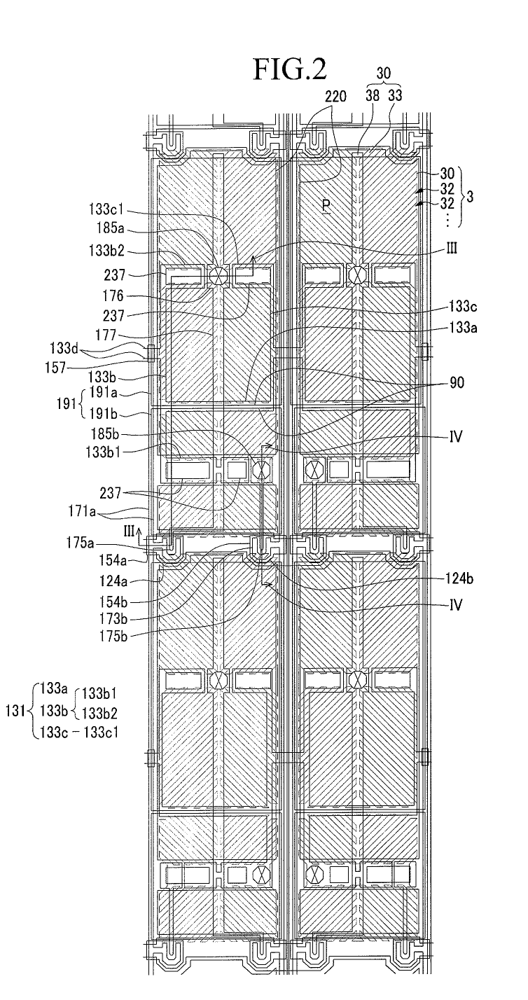

A liquid crystal display according to an embodiment of the present invention will be described in details with reference to FIG. 2 to FIG. 4.

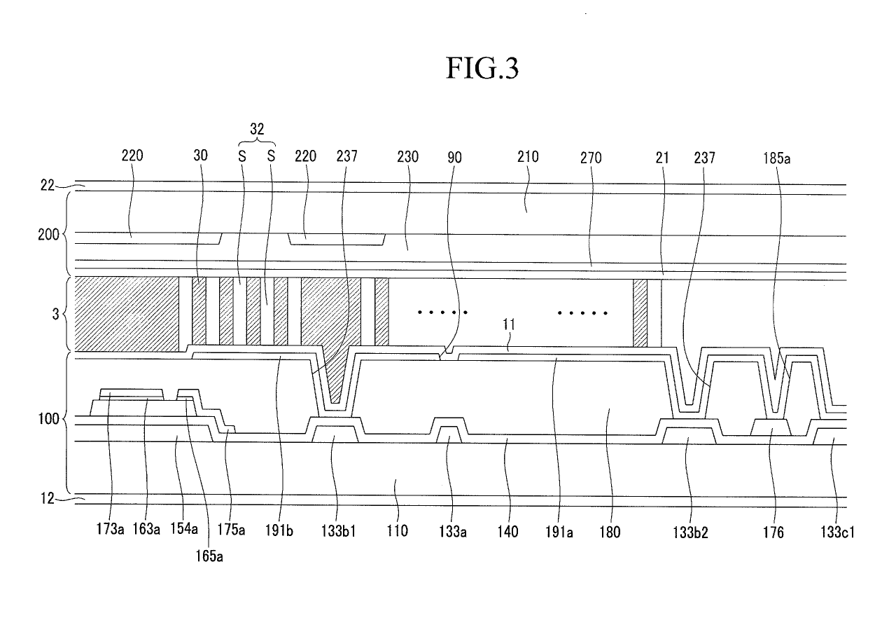

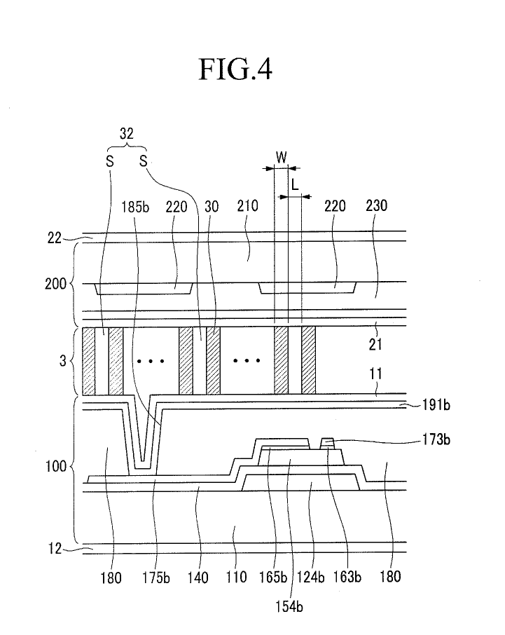

FIG. 2 is a layout view of a liquid crystal display according to an embodiment of the present invention, FIG. 3 is a sectional view of the liquid crystal display shown in FIG. 2 taken along the line III-III, and FIG. 4 is a sectional view of the liquid crystal display shown in FIG. 2 taken along the line IV-IV.

Referring to FIG. 2 to FIG. 4, the liquid crystal display according to an embodiment of the present invention includes a thin film transistor array panel 100, a common electrode panel 200 facing the thin film transistor array panel 100, and a liquid crystal layer 3 interposed between the panels 100 and 200.

First, the thin film transistor array panel 100 will be described.

A plurality of gate lines 121 and a plurality of storage electrode lines 131 are formed on an insulating substrate 110 made of a material such as transparent glass or plastic.

The gate lines 121 transmit gate signals and extend substantially in a transverse direction. Each of the gate lines 121 includes a plurality of first and second gate electrodes 124a and 124b projecting upward and downward.

Each storage electrode line 131 includes first to third storage electrodes 133a, 133b, and 133c, and a connection 133d.

The first storage electrode 133a extends substantially parallel to the gate lines 121, and is closer to the lower of the two adjacent gate lines 121. The second storage electrode 133b extends upward and downward from one end portion of the first storage electrode 133a, and the widths of two end portions 133b1 and 133b2 of the second storage electrode 133b are extended to improve the storage capacitance. The third storage electrode 133c extends upward from the other end portion of the first storage electrode 133a, and the width of an end portion 133c1 of the third storage electrode 133c is extended to improve the storage capacitance. The upper end portion 133b2 of the second storage electrode 133b and the end portion 133c1 of the third storage electrode 133c face each other and are disposed in a straight line.

The connection 133d connects the second storage electrode 133b with the third storage electrode 133c of an adjacent pixel. However, the storage electrode lines 131 may have various shapes and arrangements.

The gate lines 121 and the storage electrode lines 131 are preferably made of an Al-containing metal such as Al and an Al alloy, a Ag-containing metal such as Ag and a Ag alloy, a Cu-containing metal such as Cu and a Cu alloy, a Mo-containing metal such as Mo and a Mo alloy, Cr, Ta, or Ti. However, gate and storage lines 121, 131 may have a multi-layered structure including two conductive films (not shown) having different physical characteristics.

The lateral sides of the gate lines 121 and the storage electrode lines 131 are inclined relative to a surface of the substrate 110, and the inclination angle thereof ranges from about 30 to 80 degrees.

A gate insulating layer 140 made of, for example, silicon nitride (SiNx) or silicon oxide (SiOx) is formed on the gate lines 121 and the storage electrode lines 131.

A plurality of semiconductor islands 154a, 154b, and 157 made of, for example, hydrogenated amorphous silicon (abbreviated to “a-Si”) or polysilicon are formed on the gate insulating layer 140.

The semiconductors 154a and 154b are disposed over the first and second gate electrodes 124a and 124b, respectively, and include extensions covering edges of the gate line 121. The semiconductor 157 is disposed over the connection 133d and covers edges of the connection 133d.

A plurality of pairs of ohmic contact islands 163a and 165a, and 163b and 165b, are formed on the semiconductors 154a and 154b, respectively. The ohmic contacts 163a, 163b, 165a, and 165b are made of, for example, n+ hydrogenated a-Si heavily doped with an n-type impurity such as phosphorous, or they may be made of silicide. The ohmic contacts 163a and 165a are located in pairs on the semiconductors 154a, and the ohmic contacts 163b and 165b are located in pairs on the semiconductors 154b. A plurality of ohmic contact islands (not shown) may be formed on the semiconductors 157.

The lateral sides of the semiconductors 154a and 154b and the ohmic contacts 163a, 163b, 165a, and 165b are inclined relative to the surface of the substrate 110, and the inclination angles thereof are, for example, in a range of about 30 to 80 degrees.

A plurality of data lines 171a and 171b and a plurality of drain electrodes 175a and 175b are respectively formed on the ohmic contacts 163a and 165a, and 163b and 165b, and on the gate insulating layer 140.

The data lines 171a and 171b transmit data signals and extend substantially in the longitudinal direction to intersect the gate fines 121, and each data line 171a and 171b includes an end portion (not shown) having a large area for contact with another layer or an external driving circuit. First and second source electrodes 173a and 173b are extended from the data lines 171a and 171b toward the first and second gate electrodes 124a and 124b, respectively.

A data driving circuit (not shown) for generating the data signals may be mounted on an FPC film (not shown), which may be attached to the substrate 110, directly mounted on the substrate 110, or integrated with the substrate 110. The data lines 171 may extend to be connected to a driving circuit that may be integrated with the substrate 110.

The first and second drain electrodes 175a and 175b are separated from the data lines 171a and 171b, and are disposed opposite the first and second source electrodes 173a and 173b with respect to the first and second gate electrodes 124a and 124b, respectively. The first and second drain electrodes 175a and 175b are respectively partly enclosed by the source electrodes 173a and 173b that are curved like a character “U”.

Each first drain electrode 175a includes a longitudinal portion 177 projecting in the longitudinal direction along with the data line 171a to the adjacent gate line 121. The longitudinal portion 177 intersects the first storage electrode 133a and the lower end portion 133b1 of the second storage electrode 133b, and the portions overlapping the lower end portion 133b1 may have a narrower width than other portions. The longitudinal portion 177 includes an extension 176 having a large area for contact with another layer. The extension 176 is disposed between the upper end portion 133b2 of the second storage electrode 133b and the end portion 133c1 of the third storage electrode 133c.

The second drain electrode 175b extends to the end portion 133b1 of the second storage electrode 133b and includes an end portion having a large area for contact with another layer. The end portion 133b1 of the second storage electrode 133b and the end portion of the second drain electrode 175b are disposed in a straight line.

The first gate electrode 124a, the first source electrode 173a, and the first drain electrode 175a along with the first semiconductor 154a form the first thin film transistor Q1 having a channel formed in the semiconductor 154a between the first source electrode 173a and the first drain electrode 175a. The second gate electrode 124b, the second source electrode 173b, and the second drain electrode 175b along with the second semiconductor 154b form the second thin film transistor Q2 having a channel formed in the semiconductor 154b between the second source electrode 173b and the second drain electrode 175b.

The data lines 171a and 171b and the first and second drain electrodes 175a and 175b are made of, for example, a refractory metal such as Cr, Mo, Ta, Ti, or alloys thereof. However, the data lines 171a and 171b and the first and second drain electrodes 175a and 175b may have a multi-layered structure including a refractory metal film (not shown) and a low resistivity film (not shown). However, the data lines 171a and 171b and the first and second drain electrodes 175a and 175b may be made of various metals or conductors.

The data lines 171a and 171b and the first and second drain electrodes 175a and 175b have inclined edge profiles, and the inclination angles thereof are in a range of about 30 to 80 degrees.

The ohmic contacts 163a, 163b, 165a, 165b are disposed only between the underlying semiconductors 154a and 154b and the overlying data lines 171a and 171b and drain electrodes 175a and 175b thereon, and reduce contact resistance therebetween. However, the semiconductors 154a and 154b include some exposed portions, which are not covered with the data lines 171a and 171b and the drain electrodes 175a and 175b, such as portions located between the source electrodes 173a and 173b and the drain electrodes 175a and 175b.

A passivation layer 180 is formed on the data lines 171a and 171b, the drain electrodes 175a and 175b, and the exposed portions of the semiconductors 154a and 154b. The passivation layer 180 is made of, for example, an inorganic insulator such as silicon nitride and silicon oxide. However, the passivation layer 180 may be made of an organic insulator and it may have a flat top surface. The organic insulator may have photosensitivity and a dielectric constant of less than about 4.0. The passivation layer 180 may include a lower film of an inorganic insulator and an upper film of an organic insulator such that it takes the excellent insulating characteristics of the organic insulator while preventing the exposed portions of the semiconductors 154a and 154b from being damaged by the organic insulator.

The passivation layer 180 has a plurality of contact holes 185a and 185b exposing the first and second drain electrodes 175a and 175b, and a plurality of openings 237. The openings 237 are disposed over the storage electrode end portions 133b1, 133b2, and 133c1 such that the thickness of the dielectric material of the storage capacitors may be thin to improve storage capacitance.

A plurality of pixel electrodes 191 are formed on the passivation layer 180. The pixel electrodes 191 are made of, for example, a transparent conductor such as ITO or IZO or a reflective conductor such as Ag, Al, Cr, or alloys thereof.

Each pixel electrode 191 includes the first and second sub-pixel electrodes 191a and 191b that are separated from each other with a gap 90 therebetween.

The first and second sub-pixel electrodes 191a and 191b have a quadrangle planar shape, and the longitudinal length of the first sub-pixel electrode 191a is about twice as long as the longitudinal length of the second sub-pixel electrode 191b.

The first and second sub-pixel electrodes 191a and 191b are physically and electrically connected to the first drain electrode 175a and the second drain electrode 175b through the contact holes 185a and 185b, respectively, such that the first and second sub-pixel electrodes 191a and 191b are supplied with the data voltages from the first drain electrode 175a and the second drain electrode 175b, respectively.

The first and second sub-pixel electrodes 191a and 191b supplied with the data voltages generate electric fields in cooperation with a common electrode 270 of the common electrode panel 200 that is supplied with a common voltage. The electric fields determine the orientations of liquid crystal molecules of the liquid crystal layer 3 disposed between the first and second sub-pixel electrodes 191a and 191b and the common electrode 270. The orientations of liquid crystal molecules of the liquid crystal layer 3 adjust polarization of incident light to the liquid crystal layer 3. The first and second sub-pixel electrodes 191a and 191b and the common electrode 270 form capacitors referred to as “liquid crystal capacitors,” which store applied voltages after the thin film transistors turn off.

The first and second sub-pixel electrodes 191a and 191b and the storage electrode line 131 overlap each other to form additional capacitors Csta and Cstb referred to as “storage capacitors,” which enhance the voltage storing capacity of the liquid crystal capacitors Clca and Clcb.

Next, the common electrode panel 200 will be described in detail with reference to FIG. 2 to FIG. 4.

A light blocking member 220 is formed on an insulating substrate 210 that is made of a material such as transparent glass or plastic. The light blocking member 220 is called a black matrix and prevents light leakage.

A plurality of color filters 230 are formed on the substrate 210 and the light blocking member 220. The color filters 230 are disposed substantially in the areas enclosed by the light blocking member 220, and may extend substantially in the longitudinal direction along the pixel electrodes 191. Each of the color filters 230 may represent one of the primary colors such as red, green, and blue.

An overcoat layer (not shown), made of an organic material, is formed on the light-blocking member 220 and the color filters 230 to protect the color filters 230. The overcoat layer may be omitted.

The common electrode 270 is formed on the overcoat layer. The common electrode 270 may be made of a transparent conductive material such as ITO or IZO.

Alignment layers 11 and 21 are coated on inner surfaces of the panels 100 and 200, and they may be horizontal alignment layers or vertical alignment layers.

Polarizers 12 and 22 may be disposed on outer surfaces of the panels 100 and 200 such that their polarization axes are crossed (e.g., perpendicular to each other) and one polarization axis of the polarizers may be parallel to the gate lines 121. One of the polarizers 12 and 22 may be omitted when the liquid crystal display is a reflective liquid crystal display.

The liquid crystal display may further include at least one retardation film (not shown) for compensating the retardation of the liquid crystal layer 3. The liquid crystal display may further include a backlight unit (not shown) for supplying light to the liquid crystal layer 3 through the polarizers 12 and 22, the retardation film, and the panels 100 and 200.

The liquid crystal layer 3 includes a liquid crystal region 32 and a polymer wall 30.

The liquid crystal region 32 includes a plurality of liquid crystal molecules (not shown). The liquid crystal layer 3 of the liquid crystal region 32 has, for example, negative dielectric anisotropy and it is subjected to vertical alignment, whereby the liquid crystal molecules in the liquid crystal layer 3 are aligned such that their long axes are substantially vertical to the surfaces of the panels 100 and 200 in the absence of an electric field.

The polymer wall 30 has a long linear planar shape. The bottom and top of the polymer wall 30 contact the pixel electrodes 191 and the common electrode 270, respectively. Accordingly, the liquid crystal region 32 is divided into a plurality of linear regions S by the polymer wall 30 such that the liquid crystal molecules may not move to adjacent linear regions S.

Now, the planar disposition of the polymer wall 30 will be described in more detail.

The polymer wall 30 includes stem portions 38 and branch portions 33. The first sub-pixel electrode 191a and the second sub-pixel electrode 191b are respectively divided into four sub-regions P by the longitudinal portion 177 of the drain electrode 175a, and the second and third storage electrode end portions 133b1 and 133b2, and 133c1. The stem portions 38 of the polymer wall 30 are formed in the same direction as edges of the sub-regions P, and the branch portions 33 of the polymer wall 30 obliquely extend from the stem portions 38 to divide each sub-region P into a plurality of linear regions S. The stem portions 38 extend in a transverse direction and a longitudinal direction along with the edges of the sub-regions P.

The sub-region P of the first sub-pixel electrode 191a has a length that is about twice that of the sub-region P of the second sub-pixel electrode 191b.

The branch portions 33 of the polymer wall 30 formed in each sub-region P obliquely extend from the left upper portion to the right lower portion or from the right upper portion to the left lower portion, and make an angle of about 45 degrees to the gate lines 121. The branch portions 33 of the polymer wall 30 formed in two adjacent sub-regions P extend substantially perpendicular to each other.

A plurality of branch portions 33 of the polymer wall 30 formed in each sub-region P extend parallel to each other with a predetermined distance therebetween. Accordingly, the liquid crystal region 32 of each sub-region P has a planar shape such that a plurality of linear regions S formed as slits are disposed parallel to each other with a predetermined distance therebetween. The linear regions S of two adjacent sub-regions P may extend substantially perpendicular to each other. The width of each linear region S may be about 1 μm-about 4 μm. The distance L between adjacent polymer walls 30 and the width W of a polymer wall 30 may satisfy the relation of L/W=1−10.

As described above, the polymer wall 30 of an embodiment of the present invention divides the liquid crystal region 32 into a plurality of linear regions S such that movement of the liquid crystal molecules is restricted by the polymer wall 30 to slant in a length direction of the linear regions S when an electric field substantially perpendicular to the surface of the display panels 100 and 200 is generated.

Accordingly, the tilt directions of the liquid crystal molecules may be distributed multiple times by forming the linear regions S having various length directions such that the reference viewing angle is widened even though the pixel electrodes 191 or the common electrode 270 may not have any cutouts or protrusions. Also, according to an embodiment of the present invention, an additional mask that is required for making the cutouts and the protrusions is not used in the manufacturing processes of the liquid crystal display to reduce the manufacturing costs.

In addition, the liquid crystal molecules may not move to adjacent linear regions S. As a result, variation of alignment of the liquid crystal molecules in each linear region S may not affect alignment of the liquid crystal molecules in another linear region S during driving of the liquid crystal display. Accordingly texture or light leakage occurring by a collision between liquid crystal molecules disposed in adjacent regions may not happen.

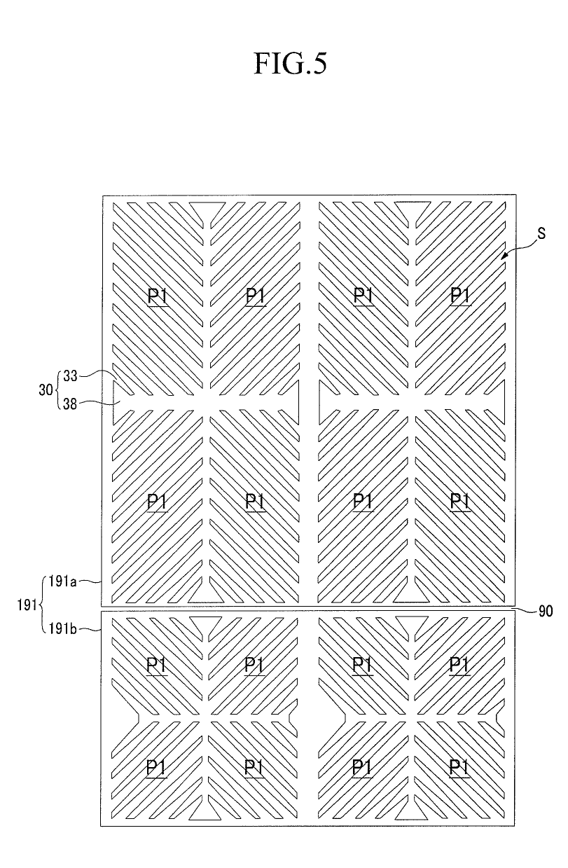

A liquid crystal display according to other embodiments of the present invention will be described with reference to FIG. 5 to FIG. 8. A layered structure of a liquid crystal display according to the present embodiments in FIG. 5 to FIG. 8 is substantially similar as that shown in FIG. 2 to FIG. 4.

FIG. 5 to FIG. 8 are layout views representing polymer walls and pixel electrodes of a thin film transistor array panel according to other embodiments of the present invention, respectively.

As shown in FIG. 5, the stem portions 38 of the polymer wall 30 divide the liquid crystal layer 3 into a plurality of sub-regions P1. Each sub-region P1 is divided by the branch portions 33 of the polymer wall into a plurality of linear regions S that are parallel to each other. The branch portions 33 of the polymer wall 30 formed in each sub-region P1 obliquely extend from the left upper portion to the right lower portion or from the right upper portion to the left lower portion, and the branch portions 33 of the polymer wall 30 formed in two adjacent sub-regions P1 extend substantially perpendicular to each other.

However, unlike the first embodiment shown in FIG. 1 to FIG. 4, the width of the branch portions 33 of the polymer wall 30 becomes narrower from edges of the pixel electrode 191 to the center of the pixel electrode 191. The width of the branch portions 33 at edges of the pixel electrode 191 and that at the center of the pixel electrode 191 have a ratio of about 5:3 based on the longest linear region S. That is, the maximum width and the minimum width of the linear region S may have a ratio of about 5:3.

The liquid crystal molecules are aligned from edges to the center of the pixel electrode 191 by electric fields formed at edges of the pixel electrode 191. The linear region S has a width that becomes wider from the center to edges of the pixel electrode 191 such that the liquid crystal molecules may slant in a length direction of the linear regions S more easily.

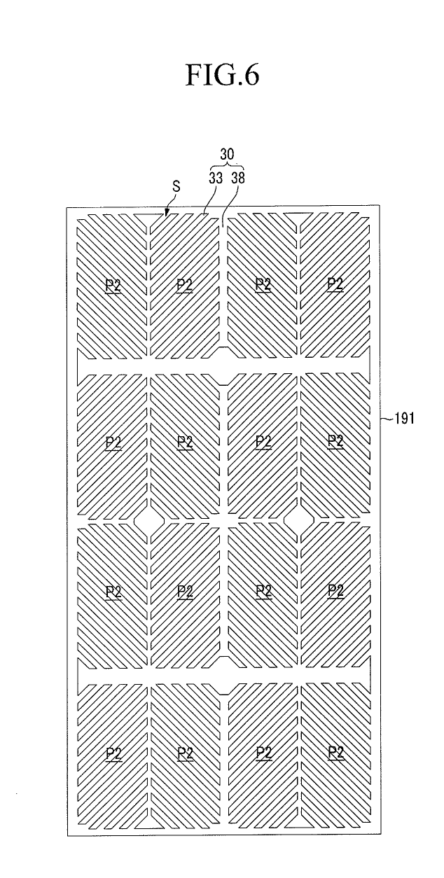

As shown in FIG. 6, the stem portions 38 of the polymer wall 30 divide the liquid crystal layer 3 into a plurality of sub-regions P2. Each sub-region P2 is divided by the branch portions of the polymer wall 30 into a plurality of linear regions S that are parallel to each other. The branch portions 33 of the polymer wall 30 formed in each sub-region P2 obliquely extend from the left upper portion to the right lower portion or from the right upper portion to the left lower portion, and the branch portions 33 of the polymer wall 30 formed in two adjacent sub-regions P2 extend substantially perpendicular to each other.

However, unlike the first embodiment shown in FIG. 1 to FIG. 4, the sub-regions P2 formed in one pixel area have the same size. Here, the pixel electrode 191 may be divided into the first sub-pixel electrode and the second sub-pixel electrode as in the first embodiment, and may be composed with one electrode.

When the pixel electrode 191 is composed with one electrode, only one thin film transistor is formed in the pixel electrode 191. Here, various shapes of the stem portion 38 cause the shapes of the sub-regions P2 to vary.

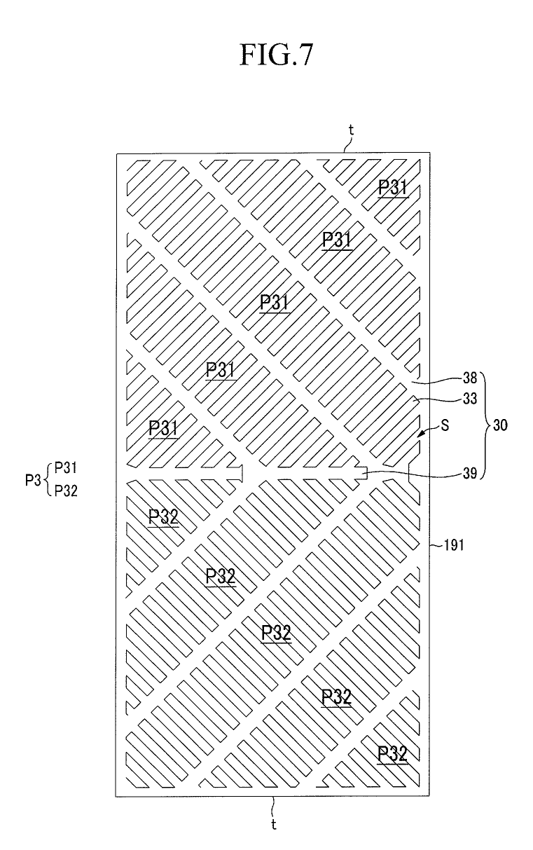

As shown in FIG. 7, the stem portions 38 of the polymer wall 30 divide the liquid crystal layer 3 into a plurality of sub-regions P3. The branch portions 33 of the polymer wall 30 formed in each sub-region P3 obliquely extend from the left upper portion to the right lower portion or from the right upper portion to the left lower portion, and the stem portions 38 dividing the sub-regions P3 extend substantially perpendicular to the branch portions 33. Accordingly, each sub-region P3 has an elongated planar shape in an oblique direction.

However, unlike the first embodiment shown in FIG. 1 to FIG. 4, the stem portions 38 are oblique to the upper and lower edges t of the pixel electrode 191. Also, the polymer wall 30 further includes a middle transverse portion 39 that is parallel to the upper and lower edges t of the pixel electrode 191 and disposed at the halfway point (middle portion) of the pixel electrode 191, and the branch portions 33 are perpendicularly connected to the stem portions 38.

The sub-regions P3 include a plurality of upper sub-regions P31 disposed above the middle transverse portion 39 and a plurality of lower sub-regions P32 disposed below the middle transverse portion 39.

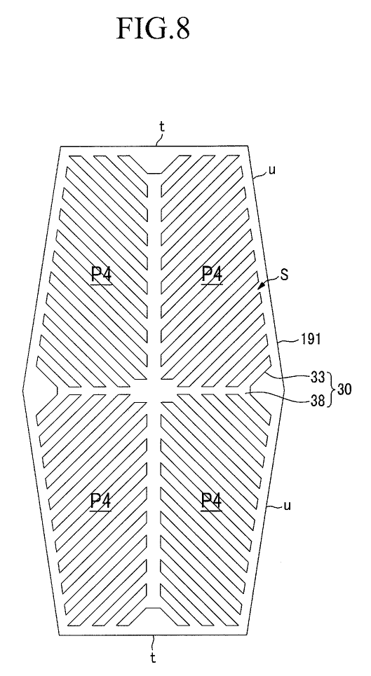

As shown in FIG. 8, the stem portions 38 of the polymer wall 30 divide the liquid crystal layer 3 into a plurality of sub-regions P4. Each sub-region P4 is divided by the branch portions 33 of the polymer wall 30 into a plurality of linear regions S that are parallel to each other. The branch portions 33 of the polymer wall 30 formed in each sub-region P4 obliquely extend from the left upper portion to the right lower portion or from the right upper portion to the left lower portion, and the branch portions 33 of the polymer wall 30 formed in two adjacent sub-regions P4 extend substantially perpendicular to each other.

However, unlike the first embodiment shown in FIG. 1 to FIG. 4, the pixel electrode 191 has a planar shape of a hexagon elongated in a longitudinal direction. The edges of the pixel electrode 191 include oblique edges u forming an obtuse angle with the upper and lower edges t of the pixel electrode 191. The stem portions 38 of the polymer wall 30 divide the pixel electrode 191 into four sub-regions P4 by twos in transverse and longitudinal directions (2×2). Here, each sub-region P4 has a trapezoid planar shape.

The pixel electrode 191 has oblique edges to enhance the lateral electric field such that alignment of liquid crystal molecules may be improved.

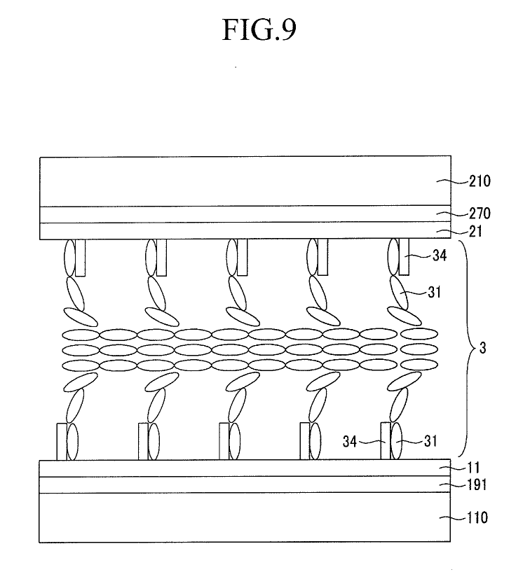

FIG. 9 is a sectional view of a liquid crystal display according to another embodiment of the present invention.

A layered structure of the liquid crystal display according to the present embodiment in FIG. 9 is substantially similar as that shown in FIG. 2 to FIG. 4. In addition, the liquid crystal display shown in FIG. 9 may have the polymer wall and the pixel electrode shown in FIG. 5 to FIG. 8.

Referring to FIG. 9, the surface of the alignment layers 11 and 21 has a plurality of side branches 34 that are perpendicular to the surface of the alignment layers 11 and 21.

The side branches 34 shown in FIG. 9 may be made of the same material as the polymer wall 30, and may have a planar pattern (not shown) of a net.

Generally, the liquid crystal molecules 31 disposed far from the alignment layers 11 and 21 are powerfully affected by an electric field, but the liquid crystal molecules 31 disposed adjacent to the alignment layers 11 and 21 are mainly affected by the alignment layers 11 and 21.

In the liquid crystal display according to the embodiment of the present invention, the liquid crystal molecules 31 disposed adjacent to the alignment layers 11 and 21 may be certainly aligned vertically by the side branches 34. Accordingly, when the generated electric field is terminated, the liquid crystal molecules 31 disposed far from the alignment layers 11 and 21 may be quickly rearranged in a direction perpendicular to the surface of the alignment layers 11 and 21 along with the alignment of the liquid crystal molecules 31 adjacent to the side branches 34 to increase a response speed of the liquid crystal display.

The liquid crystal layer 3 of the liquid crystal display according to the exemplary embodiments of the present invention may further include chiral dopants.

A manufacturing method of the liquid crystal display according to the exemplary embodiments of the present invention will be described.

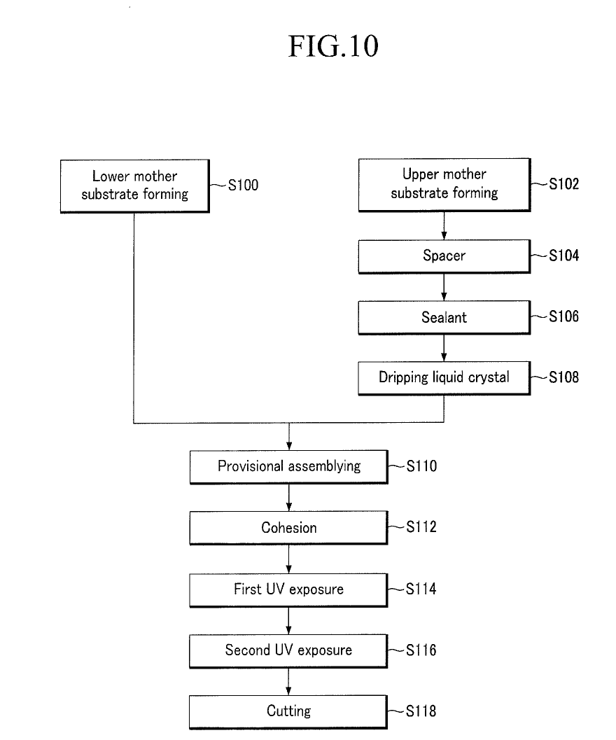

FIG. 10 is a flowchart representing a sequence of a manufacturing method for a liquid crystal cell of a liquid crystal display according to an embodiment of the present invention.

As shown in FIG. 10, upper and lower mother substrates are completed through their processes S100 and S102, and then a plurality of spacers are formed on one of the upper and lower mother substrates for maintaining a uniform interval therebetween (S104). The spacers may be dispersed bead spacers with a spherical shape, or column spacers formed by a photolithography process with a column shape.

Next, a sealing member for defining a portion where the liquid crystal layer is formed and for preventing leakage of the liquid crystal layer is formed on one of the two mother substrates (S106). The sealing member may include a material for combining the two mother substrates and may be made of a material that is hardened by light such as ultraviolet rays.

Next, liquid crystal mixtures including monomers that are polymerized by light for forming the polymer wall, a photo-initiator, chiral dopants, and liquid crystal molecules are drip-formed on one of the two mother substrates (S108). The content of the monomers may be in the range of about 0.05 about 1 wt % with respect to the content of the liquid crystal molecules. The content of the chiral dopants may be determined by a ratio of the pitch of the liquid crystal layer to the cell gap of the liquid crystal display, a range of the ratio of the pitch of the liquid crystal layer to the cell gap of the liquid crystal display is about 5 to about 150.

Next, the upper mother substrate and the lower mother substrate are combined to form a provisionally assembled liquid crystal panel assembly (S110). Next, light is irradiated to harden the sealing member disposed between the two mother substrates to cohere the two mother substrates (S112). Here, a mask may be used to selectively irradiate only the sealing member.

Next, voltages are supplied to the upper and lower display panels of the liquid crystal panel assembly and then ultraviolet rays are first exposed to the liquid crystal mixtures to form the polymer wall (S114). Here, the voltages have a range of about 3V to about 10V such that the liquid crystal molecules may have a minimum slant. The monomers may be easily moved in the liquid crystal layer to improve a polymerization reaction of the monomers by supplying voltages to the upper and lower display panels for aligning the liquid crystal molecules. In addition, the chiral dopants cause the liquid crystal molecules to align quickly to improve polymerization reaction of the monomers.

Here, a mask may be used to selectively irradiate portions where the polymer wall is formed. The monomers disposed in portions exposed to light are polymerized to form the polymer wall 30, and the monomers disposed in portions not exposed to light are moved to the portions exposed by light to be polymerized.

The content of the monomers in the liquid crystal layer is a minimum for forming the polymer wall 30 such that amount of monomers that are not polymerized is minimized.

The monomers that are not polymerized may interfere with movement of the liquid crystal molecules to cause an afterimage. Accordingly, for minimizing the amount of the monomers that are not polymerized, ultraviolet rays are secondly exposed to the liquid crystal mixtures such that the monomers remaining after the first exposure are polymerized to form the side branches 34 (S116). Here, the second exposure is processed without a mask. The monomers that are not polymerized may be moved to the alignment layers 11 and 21 and the side branches 34 may be formed on the surface of the alignment layers 11 and 21.

Next, the liquid crystal assembly is divided into a plurality of liquid crystal cells by scribing the liquid crystal assembly according to a cutting line (S118).

In a liquid crystal injection method for injecting the liquid crystal material between the two panels, the plurality of liquid crystal cells are divided and then the liquid crystal material is injected between the two panels, and then light is irradiated.

As described above, the tilt directions of the liquid crystal molecules may be distributed multiple times by forming the polymer wall having linear regions such that the reference viewing angle is widened even though the pixel electrodes or the common electrode may not have any cutouts or protrusions. The liquid crystal molecules are aligned along the linear regions to increase a response speed of the liquid crystal display.

While this invention has been described in connection with what is presently considered to be practical exemplary embodiments, it is to be understood that the invention is not limited to the disclosed embodiments, but is intended to cover various modifications and equivalent arrangements included within the spirit and scope of the appended claims.

What is claimed is:

1. A liquid crystal display, comprising:
a first substrate and a second substrate facing each other;
a common electrode formed on the first substrate;
a pixel electrode formed on the second substrate;
a liquid crystal layer disposed between the common electrode and the pixel electrode; and
a polymer wall formed between the common electrode and the pixel electrode and having a stem portion and a branch portion extended from the stem portion,
wherein the liquid crystal layer is divided into a plurality of sub-regions by the stem portion of the polymer wall, and each sub-region is divided into a plurality of linear regions by the branch portion of the polymer wall.

2. The liquid crystal display of claim 1, wherein the branch portion obliquely extends from the stem portion.

3. The liquid crystal display of claim 1, wherein the branch portion extends substantially perpendicular to the stem portion.

4. The liquid crystal display of claim 1, wherein branch portions formed in two adjacent sub-regions extend substantially perpendicular to each other.

5. The liquid crystal display of claim 1, wherein longitudinal edges of the pixel electrode have an obtuse angle to transverse edges of the pixel electrode.

6. The liquid crystal display of claim 1, wherein the width of the linear regions becomes narrower from edges of the pixel electrode to the center of the pixel electrode.

7. The liquid crystal display of claim 6, wherein the maximum width and the minimum width of a linear region have a ratio of about 5:3.

8. The liquid crystal display of claim 1, further comprising:
an alignment layer formed on at least one of the common electrode and the pixel electrode; and
a side branch formed on the surface of the alignment layer.

9. The liquid crystal display of claim 8, wherein the side branch is made of the same material as the polymer wall.

10. The liquid crystal display of claim 1, wherein the liquid crystal layer includes chiral dopants.

11. The liquid crystal display of claim 10, wherein the chiral dopants are contained in the liquid crystal layer such that a ratio of the pitch of the liquid crystal layer to the cell gap of the liquid crystal display is about 5 to about 150.

12. The liquid crystal display of claim 1, wherein the polymer wall is made of a material that is hardened by light.

13. The liquid crystal display of claim 1, wherein the stem portion comprises:
a middle transverse portion extending in a transverse direction;
an upper oblique branch portion that is upwardly and obliquely extended from the middle transverse portion; and
a lower oblique branch portion that is downwardly and obliquely extended from the middle transverse portion.

14. The liquid crystal display of claim 1, wherein the upper oblique branch portion and the lower oblique branch portion extend perpendicular to each other.
